(19) United States
(12) Patent Application Publication
(10) Pub. No.: US 2019/0037044 A1
(43) Pub. Date: Jan. 31, 2019

(54) CONTENT DISTRIBUTION AND DELIVERY OPTIMIZATION IN A CONTENT DELIVERY NETWORK (CDN)

(71) Applicants: Zhongwen ZHU, Saint-Laurent (CA); Adel LARABI, Pierrefonds (CA); Nadine GREGOIRE, Montreal (CA)

(72) Inventors: Zhongwen ZHU, Saint-Laurent (CA); Adel LARABI, Pierrefonds (CA); Nadine GREGOIRE, Montreal (CA)

(73) Assignee: TELEFONAKTIEBOLAGET LM ERICSSON (PUBL), Stockholm (SE)

(21) Appl. No.: 16/073,651

(22) PCT Filed: Mar. 1, 2016
(86) PCT No.: PCT/IB2016/051138

§ 371 Date: Jul. 27, 2018

(51) Int. Cl. H04L 29/08

(52) U.S. Cl. CPC H04L 67/2852; H04L 67/10; H04L 67/2885

(57) ABSTRACT

The disclosure relates to a method and request router (RR) to optimize content distribution in a Content Distribution Network (CDN) avoiding (unnecessary traffic towards the Content Provider) requesting the content to the origin server when the content is already available in one of the Delivery Nodes of the CDN. This is achieved by providing a path to a delivery node (DN) caching a requested content, in a content delivery network (CDN) comprising a plurality of DNs. The method comprises selecting a first DN caching the requested content. Upon determination that the first DN (90-1) has reached a maximum capacity, the method comprises selecting a second DN (90-2), which is not caching the requested content, for caching the requested content. The method comprises providing instructions, for use by the second DN, to fetch the requested content from the first DN using a reserved interface and providing a path to the second DN.

### TECHNICAL FIELD

The present disclosure relates to stateless request routing in a content delivery network.

### BACKGROUND

In order to enhance user experience, a content provider (CP) can provide its content to a content delivery network (CDN) for distribution.

Content handover from the CP to the CDN operator is done either with a push, a push-pull or a pull method. Among these methods, the pull method is more popular since the content provider has to manage content only in its own origin server. This is particularly advantageous for the content provider when dealing with live content/broadcast. In the pull method, a content provider makes its content available at its origin server and an interface address of the origin server is provided to the CDN.

The CDN can cache the content in one or many delivery nodes (DNs) which are geographically dispersed and which are usually organized as a hierarchy. The CDN operator can then deliver the content to a subscriber/end user using a selected delivery node that is configured to get the content from the origin server when the content is requested. Usually, the selected DN is close to the end user location. When the content is not available in the selected DN, it is pulled from the origin server (OS) from a DN pertaining to a high level of the hierarchy of DNs and passed down towards the selected DN.

The origin server, however, has a limited capacity and traffic towards it needs to be controlled.

### SUMMARY

There is provided a method for providing a path to a delivery node (DN) caching a requested content, in a content delivery network comprising a plurality of DNs (90). The method comprises selecting a first DN caching the requested content. The method comprises upon determination that the first DN has reached a maximum capacity, selecting a second DN, that is not caching the requested content, for caching the requested content. The method comprises providing instructions, for use by the second DN, to fetch the requested content from the first DN using a reserved interface and providing a path to the second DN.

There is provided a stateless request router (RR) operative to provide a path to a delivery node (DN) caching a requested content, in a content delivery network comprising a plurality of DNs. The RR comprises a processing circuit and a memory, the memory containing instructions executable by the processing circuit whereby the RR is operative to select a first DN caching the requested content. The RR is further operative to, upon determination that the first DN has reached a maximum capacity, select a second DN, that is not caching the requested content, for caching the requested content. The RR is further operative to provide instructions, for use by the second DN, to fetch the requested content from the first DN using a reserved interface and to provide a path to the second DN.

There is provided a stateless request router (RR) operative to provide a path to a delivery node (DN) caching a requested content, in a content delivery network comprising a plurality of DNs. The RR comprises a processing module, for selecting a first DN caching the requested content and for selecting, upon determination that the first DN has reached a maximum capacity, a second DN that is not caching the requested content, for caching the requested content. The RR comprises an input/output (I/O) module, for providing instructions, for use by the second DN, to fetch the requested content from the first DN using a reserved interface and further for providing a path to the second DN.

There is provided a non-transitory computer readable media having stored thereon instructions for providing a path to a delivery node (DN) caching a requested content, in a content delivery network comprising a plurality of DNs (90), the instructions comprising selecting a first DN caching the requested content. The instructions further comprising upon determination that the first DN has reached a maximum capacity, selecting a second DN, that is not caching the requested content, for caching the requested content. The instructions further comprising providing instructions, for use by the second DN, to fetch the requested content from the first DN using a reserved interface and providing a path to the second DN.

There is provided a request router (RR) instance, in a cloud computing environment which provides processing circuitry and memory for running the RR instance, the memory containing instructions executable by the processing circuitry whereby the RR instance is operative to select a first DN caching the requested content. The RR instance is further operative to upon determination that the first DN has reached a maximum capacity, select a second DN, that is not caching the requested content, for caching the requested content. The RR instance is further operative to provide instructions, for use by the second DN, to fetch the requested content from the first DN using a reserved interface and provide a path to the second DN.

There is provided a method comprising the step of initiating an instantiation of a request router (RR) instance in a cloud computing environment which provides processing circuits and memory for running the RR instance, the RR instance being operative to select a first DN caching the requested content. The RR instance being further operative to, upon determination that the first DN has reached a maximum capacity, select a second DN, that is not caching the requested content, for caching the requested content. The RR instance being operative to provide instructions, for use by the second DN, to fetch the requested content from the first DN using a reserved interface and provide a path to the second DN.

### BRIEF DESCRIPTION OF THE DRAWINGS

FIG. 1 a schematic illustration of a network including a content delivery network according to an embodiment.

FIG. 2 is a diagram illustrating data flow between content delivery network nodes according to an embodiment.

FIG. 3 is a diagram illustrating data flow between content delivery network nodes according to another embodiment.

FIG. 4 a schematic illustration of a content delivery network according to an embodiment.

FIG. 5 a schematic illustration of a content delivery network according to another embodiment.

FIG. 6 a schematic illustration of a two content delivery networks according to an embodiment.

FIG. 7a is a flowchart of a method according to an embodiment.

FIG. 7b is a flowchart of a method according to another embodiment.

FIGS. 8 and 9 are schematic illustrations of a stateless request router according to some embodiments.

FIGS. 10 and 11 are schematic illustrations of a cloud environment in which some embodiments can be deployed.

FIG. 12 is a flowchart of a method according to an embodiment.

### DETAILED DESCRIPTION

Various features and embodiments will now be described with reference to the figures to fully convey the scope of the disclosure to those skilled in the art.

Many aspects will be described in terms of sequences of actions or functions. It should be recognized that in some embodiments, some functions or actions could be performed by specialized circuits, by program instructions being executed by one or more processors, or by a combination of both.

Further, some embodiments can be partially or completely embodied in the form of computer-readable carrier or carrier wave containing an appropriate set of computer instructions that would cause a processor to carry out the techniques described herein.

In some alternate embodiments, the functions/actions may occur out of the order noted in the sequence of actions. Furthermore, in some illustrations, some blocks, functions or actions may be optional and may or may not be executed.

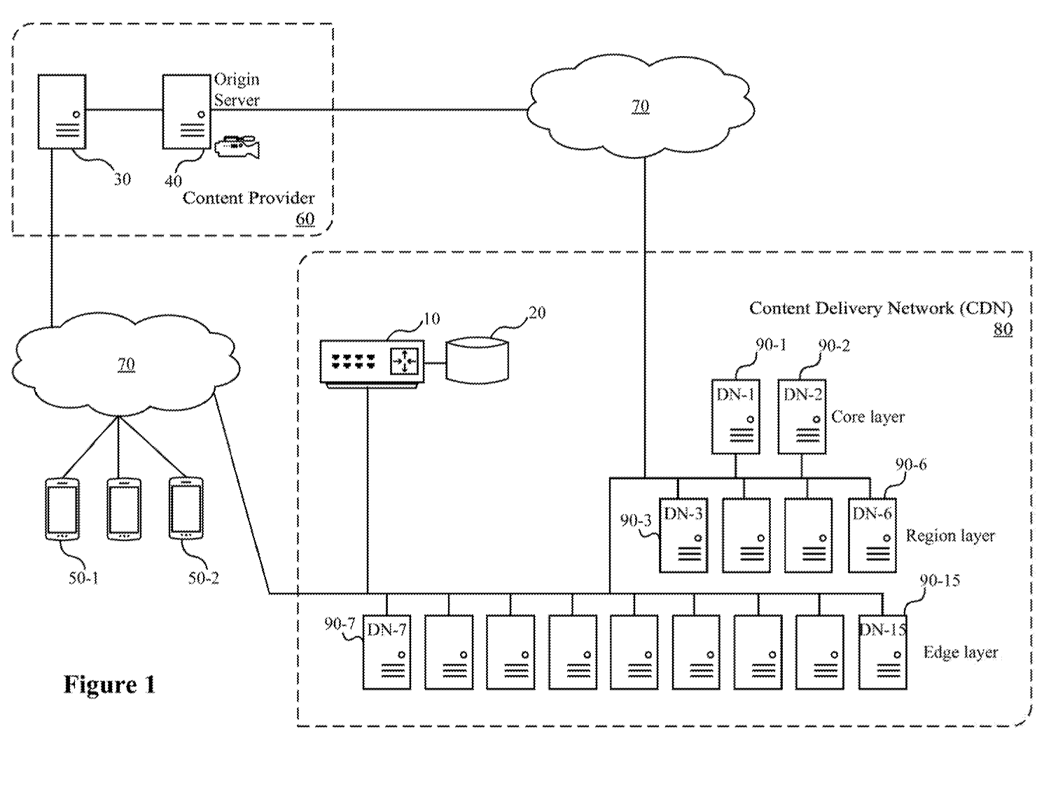

FIG. 1 illustrates a content delivery network (CDN) 80 deployed with a layer structure. Delivery nodes (DNs) 90 are deployed in edge, region and core layers. The DNs 90 at the edge layer face end user devices 50 while the delivery nodes 90-1 and 90-2 at the core layer connect to the content provider's 60 origin server (OS) 40. The content provider also comprises a portal 30 which provides Hyper Text Transfer Protocol (HTTP) access to interne protocol (IP) networks 70.

The Request Router (RR) 10 is responsible for redirecting CDN traffic, which comprises traffic between the end users and delivery nodes at the edge layer, traffic among delivery nodes at edge, region and core layers and traffic between delivery nodes at core layers and content providers' origin. The RR can communicate with a database 20 containing the information about the accounts, service offering, delivery nodes and origin server(s); the database contains static information.

In order to reduce the footprint in the cache of delivery nodes and to provide efficient routing between the delivery nodes or different layers, a content-based hashing algorithm (e.g. rendez-vous hashing, consistent hashing, or other algorithm etc.) can be used in the RR 10 to make routing decisions. This type of routing is called content based request routing (CBRR).

Still referring to FIG. 1, for example, two clients 50-1 and 50-2 request for the same content offered by the content provider 60. After the content-based hashing algorithm is applied, the delivery node DN-1 90-1 at the core layer is picked to get the content from the origin server 40. The request travels in the CDN from the device 50-1 to DN-7 90-7 and to DN-3 90-3 and then to DN-1 90-1. Then, the content is cached in DN-1 90-1 for serving requests received afterwards.

A problem appears when the traffic overloads DN-1 90-1. In a case of overload of DN-1, according to solutions that exist today, the traffic is directed towards DN-2 90-2, for example from the device 50-2 through DN-15 90-15, DN-6 90-6, and finally DN-2 90-2 instead of DN-1 90-1. DN-2 90-2 gets the content from origin server 40 directly. It is thus the second time that the content is pulled from the origin server by this CDN.

Getting the content from the origin server 40 leads to unnecessary traffic towards the Content provider's 60 origin server 40.

A solution is therefore proposed in which the traffic towards the origin server 40 is controlled based upon content presence in the CDN 80. As soon as the content is successfully fetched from the origin server 40, the delivery nodes 90 within the CDN 80 contact request router RR 10 to locate the delivery node 90 caching the content and to fetch the content from this delivery node instead of sending the request to the origin server 40.

One challenge is to still keep RR 10 stateless.

Throughout this disclosure, examples will be given using DN-1 and DN-2 as example nodes. Nevertheless, the mechanism for traffic control between delivery nodes 90 at the core layer and the origin server 40 can also be applied to traffic control between other levels of the CDN 80 and also between clusters of DNs and between CDNs.

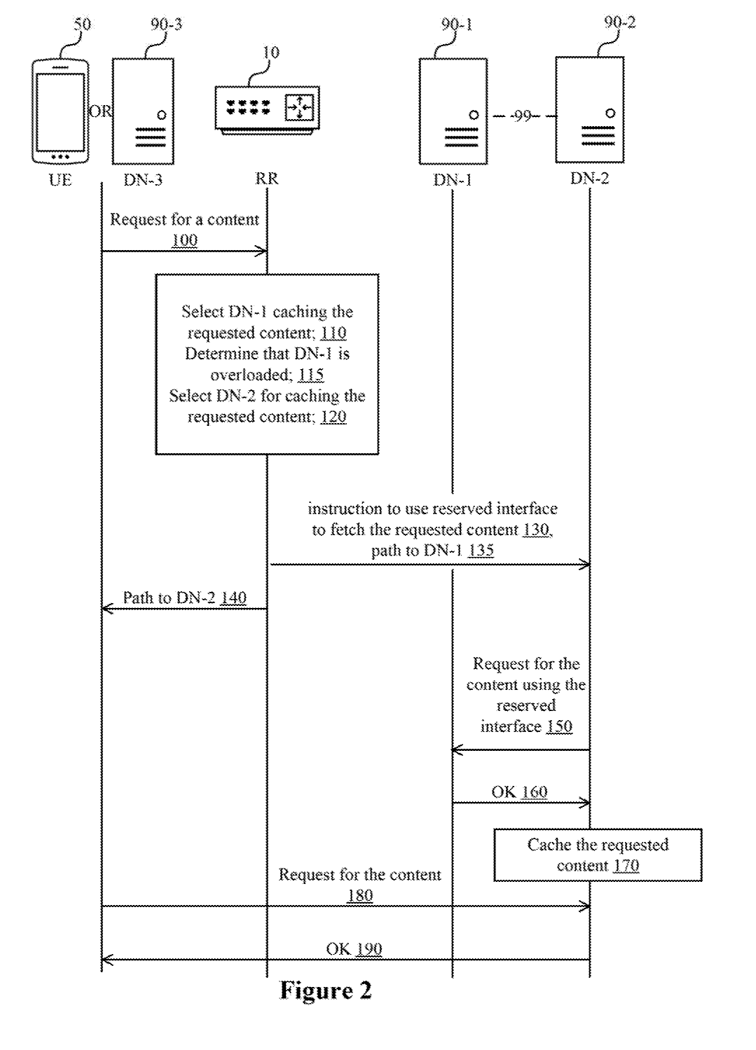

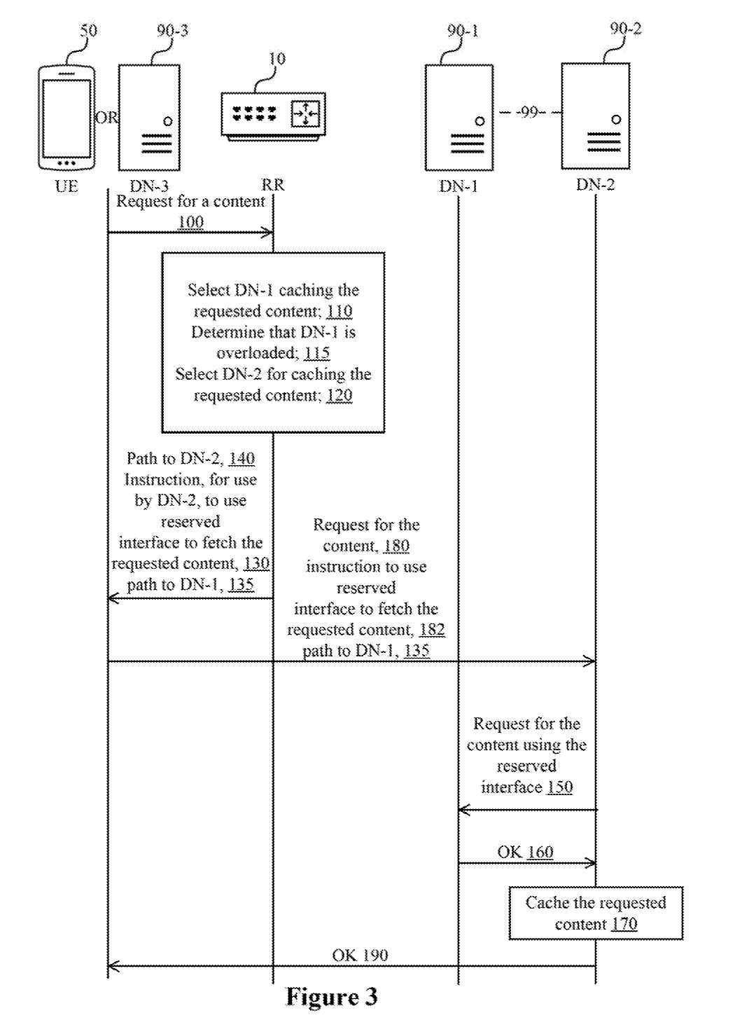

Turning to FIGS. 2 and 3, there is provided a method for providing a path to a delivery node (DN) 90-2 caching a requested content, in a content delivery network 80 comprising a plurality of DNs 90. The method can comprise receiving a request for content, step 100, which may comprise a uniform resource locator (URL) for the content. The method comprises selecting, step 110, a first DN 90-1 caching the requested content. The method comprises, upon determination, step 115, that the first DN 90-1 has reached a maximum capacity, selecting, step 120, a second DN 90-2, that is not caching the requested content, for caching the requested content. The method also comprises providing instructions, step 130, for use by the second DN (90-2), to fetch the requested content from the first DN (90-1) using a reserved interface. The method also comprises providing a path, step 140, to the second DN (90-2).

The reserved interface is a network interface. It is a point of interconnection between a delivery node and a private or public network. The network interface can take the form of a network interface card (NIC), but does not have to have a physical form. Instead, the network interface can be implemented in software. For example, the reserved interface can be access through “reserved-if.dn.cdn”, which is a fully qualified domain name (FQDN) that can be mapped to an IP address such as “142.120.10.1”. It can take the form of any IPv4/IPv6 address, for example. An IPv4 or and IPv6 address is not a physical device but a piece of software simulating a network interface.

In FIGS. 2 and 3, a traffic flow between two layers is provided. For example, DN-3 90-3 may be located in layer K, such as the edge layer or the region layer, for example, and DN-1 and DN-2 may be located in layer K+1, such as the region layer or the core layer respectively. Layers K and K+1 could also be core layer and origin server respectively, for example.

In the method, the selection of the first DN 90-1 can be done using a hashing algorithm, such as rendez-vous hashing, consistent hashing, or an other hashing algorithm.

Referring to FIG. 2, the instructions can be provided directly to the second DN 90-2 from the RR 10, step 130.

Alternatively, referring to FIG. 3, the instructions can be provided, step 130, to a user equipment (UE) 50 or a third DN 90-3 which provides it, step 182, to the second DN 90-2 through a request for the content, step 180. In the method, the third DN 90-3 may not be in a same layer of the CDN 80 as the second DN 90-2.

The instructions may comprise a path 135 to the first DN 90-1, the path embedding the instructions to use the reserved interface. The reserved interface may be in some instances a reserved streaming interface. The path may comprise a fully qualified domain name (FQDN) or an internet protocol (IP) address embedding the instructions to use the reserved interface.

At step 150, the second DN 90-2 requests the content from the first DN 90-1 using the reserved interface. At step 160, the first DN responds with OK and the content can be cached by the second DN 90-2 at step 170. Once the content is cached in the second DN 90-2, a request for the content can be sent, step 180, and answered with OK, step 190.

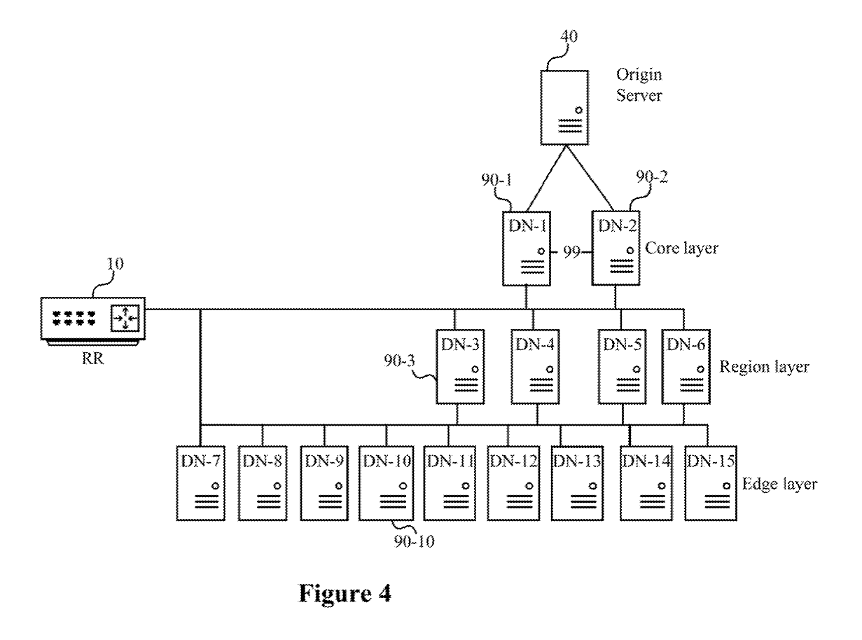

A high-level traffic flow according to an embodiment is illustrated in FIG. 4. Three cases are considered in view of this figure.

In the first case all the delivery nodes within CDN work normally. A request for a content from a client (not illustrated) is received at the edge node DN-10 90-10. It is the first request for the requested content. The request takes a path made of of DN-10 90-10, DN-3 90-3 and DN-1 90-1 which is a core node. Core delivery node DN-1 90-1 doesn't find the content in its cache and sends a request for the content to the origin server 40. After receiving the response from the origin server 40, core delivery node DN-1 90-1 stores the requested content in its cache and sends the response to the client through the reverse path, i.e. DN-1 90-1, DN-3 90-3 and DN-10 90-10. From now on, requests for the same content can be served by DN-1 90-1 from its cache.

In the second case, the core delivery node DN-1 90-1 is blacklisted, i.e. it has reached or exceeded its maximum capacity or it is overloaded. The RR 10 directs a request received at edge node DN-10 90-10 through a path made of DN-10 90-10, DN-3 90-3 and DN-2 90-2. DN-2 90-2 contacts the RR 10 to get the next server for the requested content since it doesn't cache the requested content. In this case, the RR 10 returns the IP address of the reserved interface 99 in core delivery node DN-1 90-1, which allows core DN-2 90-2 to fetch the content from the core delivery node DN-1 90-1 cache.

In a third case, we consider again that the content is cached only in DN-1 90-1. In this case, the core delivery node DN-1 has crashed and cannot be reached at all. The RR 10 directs the request received at edge node DN-10 90-10 to DN-2 90-2, through a path made of DN-10 90-10, DN-3 90-3 and DN-2 90-2, which in these circumstances can only get the requested content from the origin server 40.

The logic for handling these scenarios to make a correct routing decision for core delivery nodes is done in the RR 10. Although the example and analysis are given by focusing on the traffic between core delivery node and origin server, the same mechanism can be applied to the traffic between layers to make the CDN more efficient. It can also be used to control the traffic among different CDN operators.

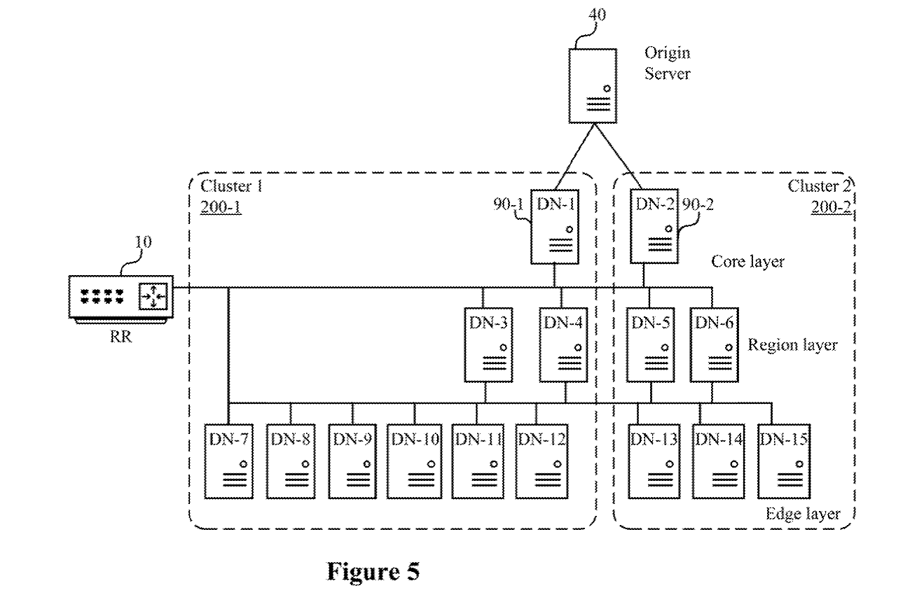

As illustrated in FIG. 5, in some embodiments, the first DN 90-1 may be in a first cluster 200-1 of DNs and the second DN may be in a second cluster 200-2 of DNs.

The method can therefore be used to control traffic between groups of delivery nodes that are located in two sites. For example, the delivery nodes can be grouped according to their physical location. Nine delivery nodes are deployed in site A, cluster 1 200-1, and the remaining delivery nodes are deployed in site B, cluster 2 200-2. Data is sent between the two sites using the internet 70. The same method as described above can be used to control traffic between the sites and a reserved interface 99 can be used to transfer cached content between delivery nodes (e.g. DN-1 90-1 and DN-2 90-2) of the sites to avoid having to contact the origin server 40.

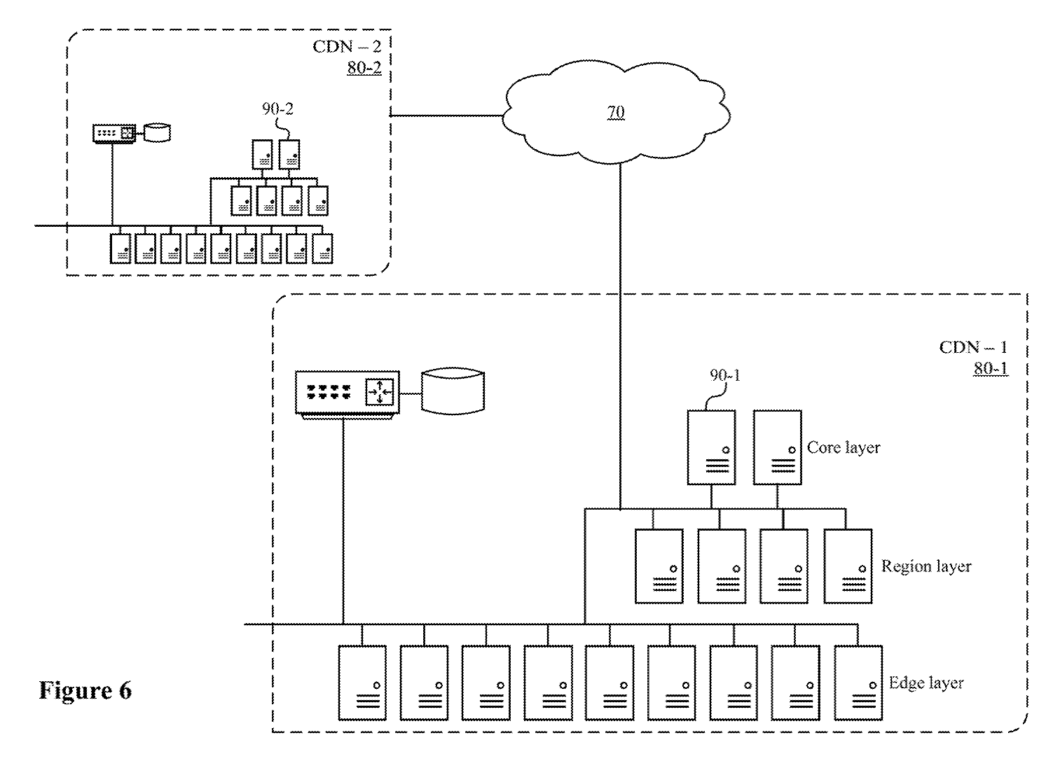

As illustrated in FIG. 6, in some embodiments, the first DN 90-1 may be in a first CDN 80-1 and the second DN 90-2 may be in a second CDN 80-2.

The method can therefore be used to control traffic between distant or distinct content delivery networks. A number of delivery nodes are deployed, possibly in the form of a hierarchy in CDN-1 80-1, and other delivery nodes are deployed, possibly in the form of a hierarchy in CDN-2 80-2. Data is sent between the two CDNs using the internet 70. The same method as described above can be used to control traffic between the CDNs and a reserved interface 99 can be used to transfer cached content between delivery nodes (e.g. DN-1 90-1 and DN-2 90-2) of the CDNs to avoid having to contact the origin server.

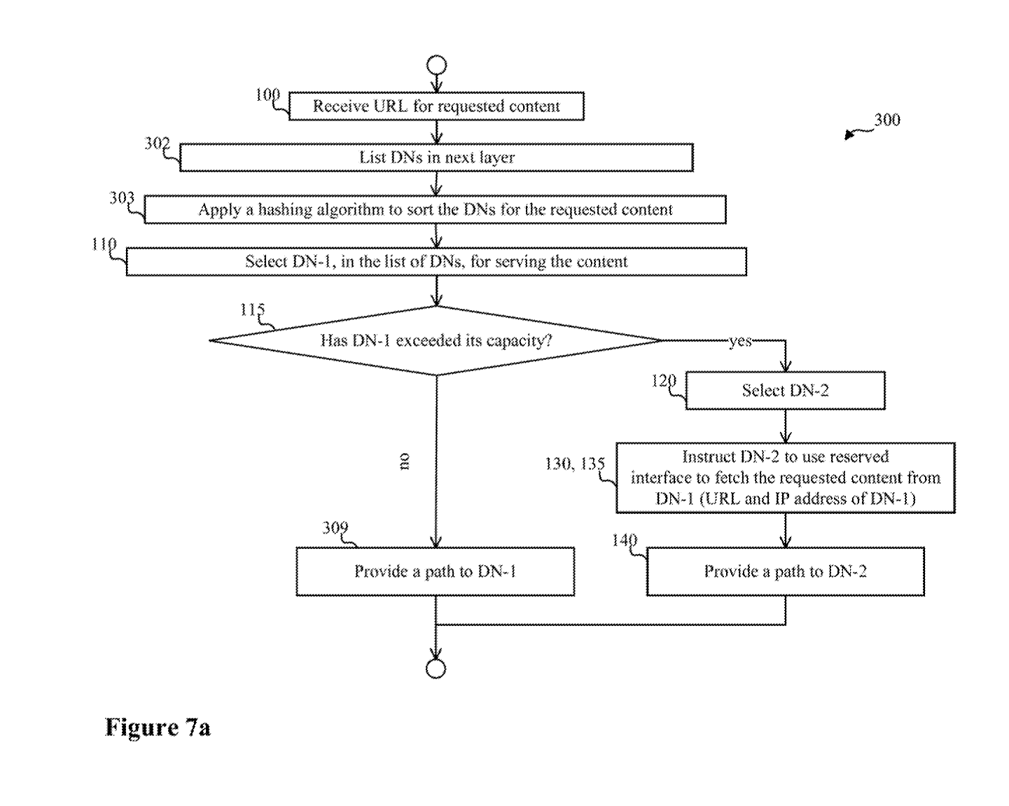

FIG. 7a is a flowchart of a high-level method 300 for stateless request routing according to an embodiment. In the method 300, a request for a content is received, step 100, which comprises a URL for the requested content. In the next step 302, the RR 10 produces a list of DNs 90 in the next layer of the content delivery network. Then, at step 303, the RR 10 applies a hashing algorithm to sort the DNs in the list for the requested content. The RR then selects DN-1, step 110, in the list of DNs, for serving the content.

At step 115, there is a check made by the RR 10 to determine if the selected DN-1 has exceeded its capacity. If not, a path to DN-1 is provided in response to the request at step 309. If the selected DN-1 has exceeded its capacity, DN-2 is selected to cache the requested content, at step 120. Then the RR instructs DN-2 to use the reserved interface to fetch the requested content from DN-1, step 130. The URL for the content and an IP address 135 for DN-1 can be passed along with the instructions. The path to DN-2 is then provided in response to the request at step 140.

FIG. 7b is a detailed flowchart of a method 350 according to an embodiment in which the selection of the second DN 90-2 comprises selection of a list of second DNs.

In the method 350, a request for a content is received, step 100. A first list of DNs, in a current layer of the CDN, is produced at step 351. In the next step 302, the RR 10 produces a list of DNs in the next layer of the content delivery network, filters the DNs having exceeded their capacity and the offline DNs. Then, at steps 110, 303, the RR 10 applies a hashing algorithm and selects DN-1 in the first list of DNs, for serving the content. At step 352, it is verified if DN-1, selected in the first list in the current layer for caching the content, is the same as the DN having made the request. The hashing algorithm may have selected the requesting DN for caching the content, as would be apparent to a person skilled in the art.

If DN-1, selected in the current level for caching the content, is the same DN that made the request, a DN-2 in the list for the next level is selected for providing the content, step 354. DN2 is then added to a final list at step 355.

If the DN selected in the current level for caching the content is not the same DN that made the request, at step 353, it is verified if DN-1 is offline.

If DN-1 is offline, a DN-2 in the list for the next level is selected for providing the content, step 354.

If DN-1 is not offline, at step 115, there is a check made by the RR 10 to determine if the selected DN-1 has exceeded its capacity.

If the selected DN-1 has exceeded its capacity, DN-2 is selected to cache the requested content, at step 120. Then the RR instructs DN-2 to use the reserved interface to fetch the requested content from DN-1, step 130. The URL for the content and an IP address 135 for DN-1 can be passed along with the instructions. DN-2 is added to the final list at step 355.

If the selected DN-1 has not exceeded its capacity DN-1 is added to the final list at step 355.

Then, it is verified if the final list contains at least two candidate DNs, step 356, from which the content can be requested, for higher availability purpose (to provide redundancy). The final list is provided in response to the request at step 357. This final list can be referred to as the list of second DNs, although it can comprise DNs of the current layer.

In the list of second DNs, the DNs may comprise attributes such as processing circuit usage, memory usage, bandwidth usage, latency, state of network connection, traffic load, physical location proximity, weight round-robin (WRR). The list of second DNs may further be sorted to provide best DNs first and can comprise any number of DN(s) greater or equal to one, as would be apparent to a person skilled in the art.

The routing decision made by the RR of the embodiment of FIG. 7b is made based on the content presence in the current layer (K) and next layer (K+1), the availability of the delivery nodes at both layers, and location proximity between delivery nodes.

The list of the current layer contains a list of delivery nodes at layer K that might have the request content, sorted with priority. The list of the next layer contains a list of delivery nodes at layer K+1 that might have the request content, sorted with priority. From both lists, the RR produces a list of delivery nodes that can be used by the requested delivery node to fetch the content. A person skilled in the art would understand that this is a general mechanism to control traffic between delivery nodes located in two consecutive layers, where a higher layer is closer to the content provider origin. It can be applied at different layers e.g. user-edge, edge-region, region-core and core-origin server.

A person skilled in the art will notice that, with the proposed methods, operators of CDNs can optimize the content delivery towards clients, can control traffic towards content provider's origin, and can make internal traffic routing more efficient. Content Providers can reduce traffic towards their origin servers and subscribers can have a good user experience.

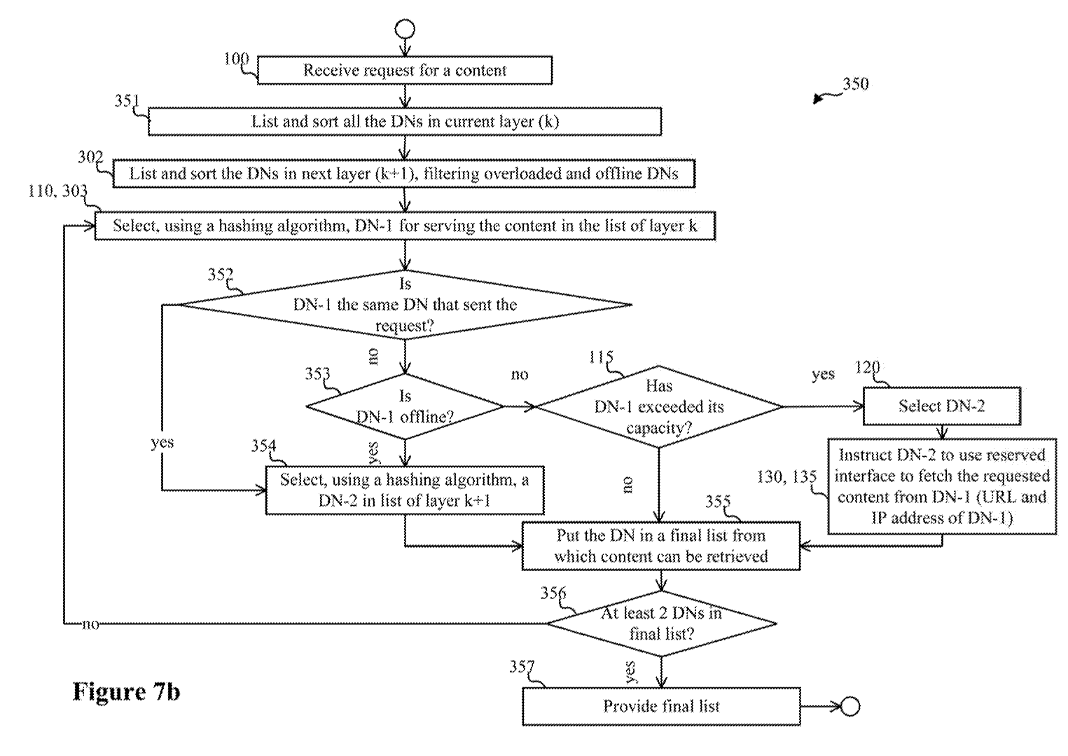

The stateless request router (RR) 10 illustrated in FIG. 8 is operative to provide a path to a delivery node (DN) 90-2 caching a requested content, in a content delivery network 80 comprising a plurality of DNs 90, the RR 10 comprises a processing circuit 400 and a memory 410, the memory 410 containing instructions executable by the processing circuit 400 whereby the RR 10 is operative to execute the method illustrated in FIGS. 2, 3 and 7.

The RR 10 includes a communications interface 420. The communications interface 420 generally includes analog and/or digital components for sending and receiving communications to and from mobile devices 50 via wired or within a wireless coverage area of the RR 10, as well as sending and receiving communications to and from delivery nodes 90, either directly or via a network 70. Those skilled in the art will appreciate that the block diagram of the RR 10 necessarily omits numerous features that are not necessary for a complete understanding of this disclosure.

Although all of the details of the RR 10 are not illustrated, the RR 10 comprises one or several general-purpose or special-purpose processors 400 or other microcontrollers programmed with suitable software programming instructions and/or firmware to carry out some or all of the functionality of the RR 10 described herein.

In addition, or alternatively, the RR 10 may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the RR 10 described herein. A memory 410, such as a random access memory (RAM), may be used by the processor 400 to store data and programming instructions which, when executed by the processor 400, implement all or part of the functionality described herein. The RR 10 may also include one or more storage media 430 for storing data necessary and/or suitable for implementing the functionality described herein, as well as for storing the programming instructions which, when executed on the processor 400, implement all or part of the functionality described herein.

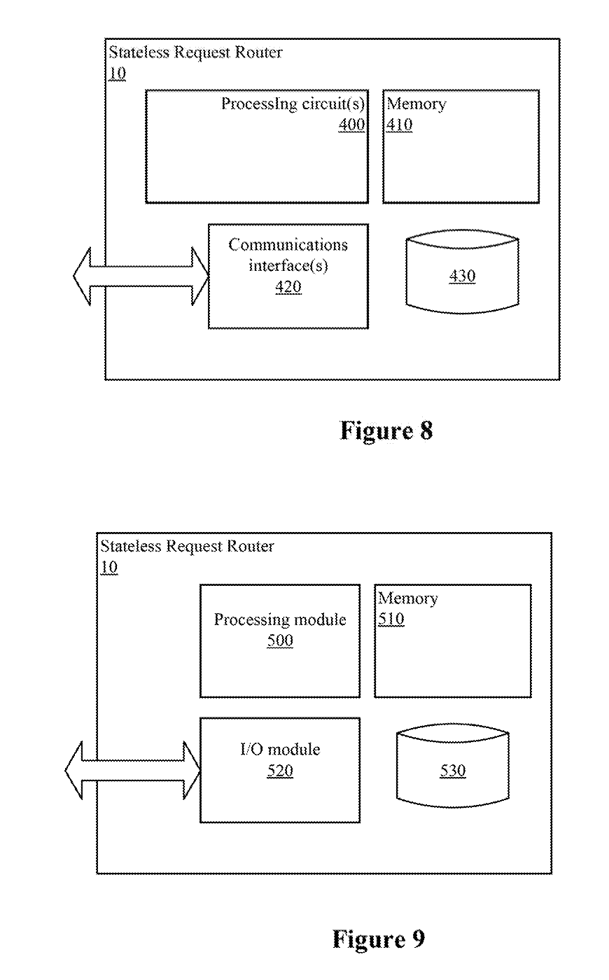

FIG. 9 illustrates another embodiment of a stateless request router (RR) 10 operative to provide a path to a delivery node (DN) 90-2 caching a requested content, in a content delivery network 80 comprising a plurality of DNs 90, the RR 10 comprising a processing module 500 and a memory 510, the processing module 500 selecting a first DN 90-1 caching the requested content. The processing module 500 further selecting, upon determination that the first DN 90-1 has reached a maximum capacity, a second DN 90-2 that is not caching the requested content, for caching the requested content. The RR 10 comprises an input/output (I/O) module 520, for providing instructions, for use by the second DN 90-2, to fetch the requested content from the first DN 90-1 using a reserved interface 99 and for providing a path to the second DN 90-2.

One embodiment of the present disclosure may be implemented as a computer program product that is stored on a non-transitory computer-readable storage media 430, 530, the computer program product including programming instructions that are configured to cause the processor 400, 500 to carry out the steps described herein in relation with FIGS. 2, 3 and 7, for providing a path to a delivery node (DN) (90-2) caching a requested content, in a content delivery network (80) comprising a plurality of DNs (90).

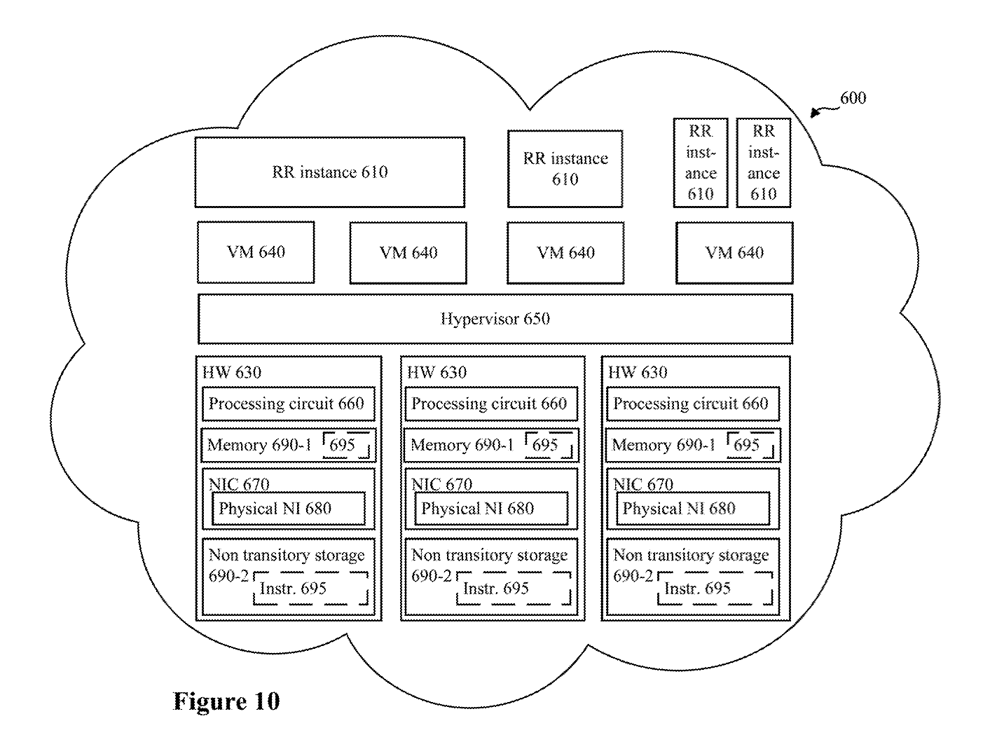

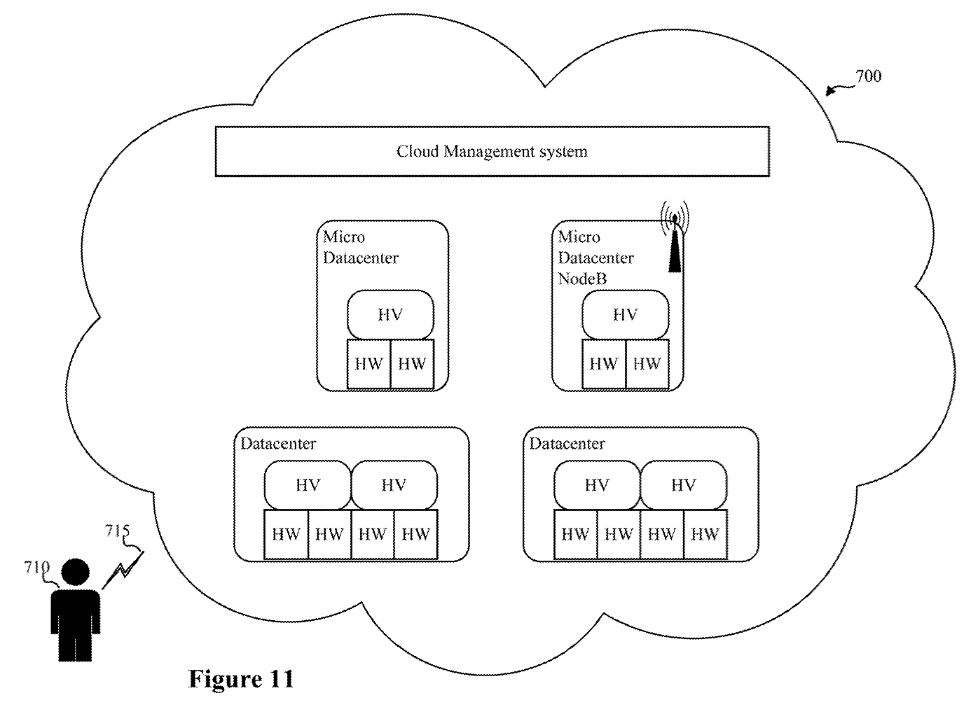

Turning to FIGS. 10 and 11, according to another embodiment, there is provided a request router (RR) instance 610, in a cloud computing environment 600, 700 (FIG. 11) which provides processing circuitry 660 and memory 690 for running the RR instance 610, the memory 690 containing instructions 695 executable by the processing circuitry 660 whereby the RR instance 610 is operative to execute the method as previously described in relation to FIGS. 2, 3 and 7.

The cloud computing environment 600, 700, comprises a general-purpose network device including hardware 630 comprising a set of one or more processor(s) or processing circuit(s) 660, which can be commercial off-the-shelf (COTS) processors, dedicated Application Specific Integrated Circuits (ASICs), or any other type of processing circuit including digital or analog hardware components or special purpose processors, and network interface controller(s) 670 (NICs), also known as network interface cards, which include physical Network Interface 680. The general-purpose network device also includes non-transitory machine readable storage media 690-1, 690-2 having stored therein software 695 and/or instructions executable by the processor 660. During operation, the processor(s) 660 execute the software 695 to instantiate a hypervisor 650, sometimes referred to as a virtual machine monitor (VMM), and one or more virtual machines 640 that are run by the hypervisor 650. A virtual machine 640 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 640, and that part of the hardware 630 that executes that virtual machine, be it hardware dedicated to that virtual machine and/or time slices of hardware temporally shared by that virtual machine with others of the virtual machine(s) 640, forms a separate virtual network element(s) (VNE).

The hypervisor 650 may present a virtual operating platform that appears like networking hardware to virtual machine 640, and the virtual machine 640 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the RR instance 610 may be implemented on one or more of the virtual machine(s) 640, and the implementations may be made differently.

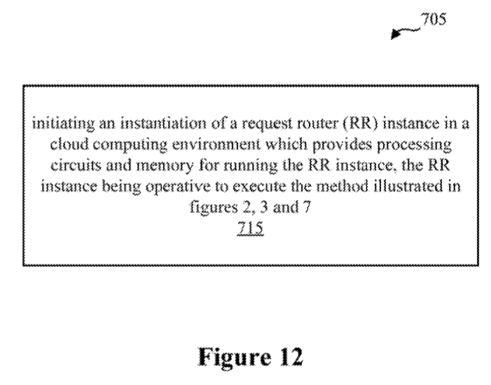

Referring to FIG. 12 there is provided a method 705 comprising the step 715 of initiating, by a user 710, an instantiation of a request router (RR) instance 610 in a cloud computing environment 600, 700, which provides processing circuit(s) 660 and memory 690 for running the RR instance 610, the RR instance 610 being operative to execute the method as previously described in relation to FIGS. 2, 3 and 7.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for providing a path to a delivery node (DN) (90-2) caching a requested content, in a content delivery network (80) comprising a plurality of DNs (90), comprising:
selecting (110) a first DN (90-1) caching the requested content;
upon determination (115) that the first DN (90-1) has reached a maximum capacity, selecting (120) a second DN (90-2), that is not caching the requested content, for caching the requested content;
providing instructions (130), for use by the second DN (90-2), to fetch the requested content from the first DN (90-1) using a reserved interface (99); and
providing a path (140) to the second DN (90-2).

2. The method of claim 1, wherein the selection of the first DN (90-1) is done using a hashing algorithm.

3. The method of claim 1, wherein the instructions are provided (130) directly to the second DN (90-2).

4. The method of claim 1, wherein the instructions are provided (130) to a user equipment (UE) (50) or a third DN (90-3) which provides it (182) to the second DN (90-2) through a request for the content (180).

5. The method of claim 4, wherein the third DN (90-3) is not in a same layer of the CDN (80) as the second DN (90-2).

6. The method of claim 1, wherein the instructions comprise a path (135) to the first DN (90-1), the path embedding the instructions to use the reserved interface (99).

7. The method of claim 1, wherein the path comprises a fully qualified domain name (FQDN) or an internet protocol (IP) address embedding the instructions to use the reserved interface (99).

8. The method of claim 1, wherein the first DN (90-1) is in a first cluster (200-1) of DNs and the second DN is in a second cluster (200-2) of DNs.

9. The method of claim 1, wherein the first DN (90-1) is in a first CDN (80-1) and the second DN (90-2) is in a second CDN (80-2).

10. The method of claim 1, wherein the selection of the second DN (90-2) comprises selection of a list of second DNs.

11. The method of claim 10, wherein the list of second DNs comprises attributes such as processing circuit usage, memory usage, bandwidth usage, latency, state of network connection, traffic load, physical proximity, weight round-robin (WRR).

12. The method of claim 10, wherein the list of second DNs in sorted to provide best DNs first.

13. A stateless request router (RR) (10) operative to provide a path to a delivery node (DN) (90-2) caching a requested content, in a content delivery network (80) comprising a plurality of DNs (90), the RR (10) comprising a processing circuit (400) and a memory (410), the memory (410) containing instructions executable by the processing circuit (400) whereby the RR (10) is operative to:
select (110) a first DN (90-1) caching the requested content;
upon determination (115) that the first DN (90-1) has reached a maximum capacity, select (120) a second DN (90-2), that is not caching the requested content, for caching the requested content;
provide instructions (130), for use by the second DN (90-2), to fetch the requested content from the first DN (90-1) using a reserved interface (99); and
provide a path (140) to the second DN(90-2).

14. The stateless RR (10) of claim 13, wherein the selection of the first DN (90-1) is done using a hashing algorithm.

15. The stateless RR (10) of claim 13, wherein the instructions are provided directly to the second DN (90-2).

16. The stateless RR (10) of claim 13, wherein the instructions are provided to a user equipment (UE) (50) or a third DN (90-3) which provides it to the second DN (90-2) through a request for the content.

17. The stateless RR (10) of claim 16, wherein the third DN (90-3) is not in a same layer of the CDN (80) as the second DN (90-2).

18. The stateless RR (10) of claim 13, wherein the instructions comprise a path to the first DN (90-1), the path embedding the instructions to use the reserved interface (99).

19. The stateless RR (10) of claim 13, wherein the path comprises a fully qualified domain name (FQDN) or an internet protocol (IP) address embedding the instructions to use the reserved interface (99).

20. The stateless RR (10) of claim 13, wherein the first DN (90-1) is in a first cluster (200-1) of DNs and the second DN (90-2) is in a second cluster (200-2) of DNs.

21. The stateless RR (10) of claim 13, wherein the first DN (90-1) is in a first CDN (80-1) and the second DN (90-2) is in a second CDN (80-2).

22. The stateless RR (10) of claim 13, wherein the selection of the second DN (90-2) comprises selection of a list of second DNs.

23. The stateless RR (10) of claim 22, wherein the list of second DNs comprises attributes such as processing circuit usage, memory usage, bandwidth usage, latency, state of network connection, traffic load, physical proximity, weight round-robin (WRR).

24. The stateless RR (10) of claim 22, wherein the list of second DNs in sorted to provide best DNs first.

25-28. (canceled)
